(19) United States
(12) Patent Application Publication
(10) Pub. No.: US 2014/0354490 A1
(43) Pub. Date: Dec. 4, 2014

(54) CHIP CARD AND METHOD FOR PRODUCING A CHIP CARD

(71) Applicant: SMARTRAC IP B.V., Amsterdam (NL)

(72) Inventor: Manfred Michalk, Erfurt (DE)

(21) Appl. No.: 14/346,550

(22) PCT Filed: Sep. 27, 2012
(86) PCT No.: PCT/EP2012/004045

§ 371 Date: Mar. 21, 2014

(30) Foreign Application Priority Data
Oct. 4, 2011 (DE) 10 2011 114 635.4

(51) Int. Cl. H01Q 1/22

(52) U.S. Cl. CPC H01Q 1/22
USPC 343/702; 29/601

(57) ABSTRACT

The invention relates to a chip card having a card body (36) which is equipped with a cavity on the top side thereof, and a chip module (37) which is inserted into the cavity in such a way that contacts (38) of the module face antenna contacts (39) of the antenna arranged in the card body, said antenna contacts being arranged in a bottom of the cavity, and in such a way that the module contacts make electrical contact with the antenna contacts via wire connections (60) which are formed by contact conductors and are arranged in the cavity, wherein the wire connections have a contact conductor cross-section whose width along a transverse axis arranged parallel to a contact surface of the antenna contacts or of the module contacts is larger than the height of said cross-section along a vertical axis arranged perpendicular to the contact surface of the antenna contacts or of the module contacts.

The following invention relates to a chip card comprising a card body which is equipped with a cavity in the top side thereof and a chip module which is arranged in the cavity, wherein the chip module is inserted into the cavity in such a manner that module contacts of the chip module face antenna contacts of an antenna arranged in the card body, said antenna contacts being arranged in a bottom of the cavity, and in such a manner that the module contacts and the antenna contacts make electrical contact via wire connections which are formed from contact conductors and are arranged in the cavity. Furthermore, the present patent application relates to a method for producing such a chip card.

From document WO 2008/129526, a chip card of the type mentioned at the beginning is known, with which antenna contacts of an antenna arranged in the card body, said antenna contacts being arranged in the bottom of a cavity of the card body, are contacted with module contacts of a chip module which is inserted into the cavity. For producing the electrically conductive connection between the chip module and the antenna arranged in the card body, initially, enlarged antenna contacts are formed in that the ends of the windings forming the antenna are equipped with metal leafs. Subsequently, terminal conductors formed as thin wires make contact with the antenna contacts formed by the metal leafs. For the subsequent contacting of the free ends of the terminal conductors formed by the thin wires, said free ends are aligned substantially perpendicular to the top side of the card body and are subsequently contacted with the module contacts of the chip module. As a consequence of inserting or fitting the chip module into the cavity, an arrangement results in which the module contacts and the antenna contacts are arranged so as to face one another and the terminal conductors formed by the thin wires are situated in a random compressed arrangement within the cavity as a consequence of inserting the module into the cavity.

The production of the known chip card turns out to be correspondingly complex since it is not possible to directly contact the terminal conductors formed as thin wires with the ends of the antenna windings forming the antenna and instead, a metal leaf for forming a sufficiently large contact surface between the terminal conductor and the antenna has to be arranged in the cavity prior thereto. In addition, in practice it proves to be a complex process to contact the free ends of the terminal conductors with the module contacts of the chip module since, initially, the terminal conductors have to be aligned in an extension which is perpendicular with respect to the card body, and subsequently, the free ends of the terminal conductors have to be handled, in order to position the same so as to overlap the module contacts, as a prerequisite for a subsequent contacting process.

Starting from this state of the art, the present invention is based on the object of proposing a chip card or a method for producing a chip card which enable a simplified production of the chip cards.

In order to attain this object, the chip card in accordance with the invention has the features of claim 1 and the method in accordance with the invention has the features of claim 11.

In accordance with the invention, the wire connections have a contact conductor cross-section whose width along a transverse axis arranged parallel to a contact surface of the antenna contacts or of the module contacts is larger than the height of said cross-section along a vertical axis arranged perpendicular to the contact surface of the antenna contacts or of the module contacts.

Using the contact conductors formed in this way, it becomes possible to form wire connections which, in contrast to a thin wire conductor having a round cross-section, have a contact surface which enables a reliable contacting with antenna contacts without the need for the same to be equipped with enlarged terminal faces prior thereto. In addition, such contact conductors have a comparatively larger directional stability in their longitudinal extension. Hereby, it is possible to position the contact conductors above a terminal face, that is to say above the module contacts of the chip module or above the antenna contacts without the need for the free end of the contact conductor to be seized itself. Instead, by means of the given directional stability of the contact conductor, it is possible to align the contact conductor in a defined way, without fixing or seizing the free end of the contact conductor.

A particularly reliable contacting of the terminal conductor with the module contacts or with the antenna contacts results if the contact conductor cross-section, as a flat ribbon cross-section, has a bottom edge and a top edge which are formed to be substantially parallel to the transverse axis.

It is particularly advantageous with regard to lodging the contact conductors in the cavity in a space-saving way, but also with regard to a particularly reliable contacting with the module contacts or with the antenna contacts, if the contact conductors have a cross-section whose width amounts to at least ten times the height of said cross-section. Preferably, the terminal conductor is formed as a foil strip.

If the contact conductors have at least one kink, a controlled space-saving arrangement of the wire connections in the cavity, for instance by means of a leporello-like folding of the contact conductors, can be achieved.

If, for forming predetermined kinks, the contact conductors have a kink cross-section having a reduced cross-sectional area, the predetermined kinks can already be predefined by means of a corresponding subdivision of the contact conductors prior to the production of the wire connection. Preferably, the kink cross-section is formed in that the same has a reduced cross-sectional height.

The implementation of a reliable contacting, over the largest scale possible, between the antenna arranged in the card body and the contact conductors can further be enhanced in that, in particular in the case of an antenna formed by a wire conductor, the contact surface of the antenna contacts is formed by an antenna conductor end which is arranged in the shape of a meander and which pertains to the antenna conductor forming the antenna. Preferably, surface areas of the antenna conductor forming the contact surface are equipped with a flat contact portion, in order to further enlarge the contact surface between the antenna and the contact conductor.

Departing from a configuration of the antenna made from a wire conductor, all other antenna configurations, which means in particular also etched or printed antennas, are, however, also possible if the antenna contacts thereof can be contacted with a wire connection.

If the antenna conductor end which is arranged in the shape of a meander has antenna conductor sections spaced apart from one another by means of antenna conductor clearances, said antenna conductor sections protruding from the bottom of the cavity, the contact surface between the antenna conductor and the contact conductor or a wetting surface formed between the contact conductor and the antenna conductor in the area of the antenna conductor end arranged in the shape of a meander is further enlarged.

The above-described advantageous configuration of antenna ends arranged in the shape of a meander and having antenna conductor sections which are separated from one another by antenna conductor clearances, wherein the antenna conductor sections preferably protrude from the bottom of a cavity, is —also independently of the manner in which a subsequent contacting with a chip module is effected—particularly advantageous in the case of a chip card or of an antenna module of a chip card which is intended for being completed by a chip module, since, due to the configuration of the antenna conductor ends which are arranged in the shape of a meander and which are preferably equipped with flat portions of the antenna conductor ends for forming an enlarged contact surface, a particularly conductive electrical contacting and, at the same time, durable electrical contacting with the chip module is enabled.

Here, in particular the arrangement of the antenna conductor sections protruding from the bottom of the cavity ensures an engaging connection of a connecting material, which is formed from soldering material or from an electrically conductive adhesive, with the antenna conductor ends.

Furthermore, in particular in the case of a cavity which is produced by means of milling in an area of the antenna conductor ends in a substrate of the antenna module, oxide-free surfaces of the antenna conductor ends result, said antenna conductor ends precluding, as far as possible, that an undesirable contact resistance forms between the antenna conductor ends and the terminal faces of a chip module which is subsequently contacted.

In accordance with the invention, for producing the chip card the chip module is positioned with module contacts aligned upwardly. Equally, the card body is positioned with antenna contacts aligned upwardly. Before the contact conductors are contacted with the module contacts, the contact conductors are positioned relative to the module contacts, in such a manner that the contact conductors are aligned parallel to one another at the distance of the module contacts, extend in an overlapping position with the module contacts and extend beyond a lateral edge of the chip module together with contact conductor ends.

For contacting the contact conductor ends with the antenna contacts, the contact conductor ends are positioned so as to overlap the antenna contacts, wherein the chip module is arranged parallel to the top side of the card body, with the lateral edge of the chip module being arranged parallel and adjacent to an opening edge of the cavity.

Following the contacting of the contact conductor ends, the contact conductor ends are separated for forming the wire connections, and the chip module is pivoted around its lateral edge, and the chip module is inserted into the cavity of the card body, in such a manner that the module contacts face the antenna contacts.

Preferably, a translational movement of the chip module superposes the pivoting.

Owing to the use of a contact conductor which is formed in the manner of a flat ribbon, aligning or longitudinally extending the contact conductor is easily possible, said aligning or extending being suited for positioning the contact conductor above the module contacts or above the antenna contacts. Therefore, it is in particular possible to effect the positioning of the chip module and the positioning of the card body in such a way that the contacts which are respectively assigned to one another for contacting, i.e. one antenna contact and one module contact in each case, are aligned flush with one another, in such a way that a relative positioning of the contact conductor with respect to the antenna contacts or the module contacts, which is suited for the subsequent contacting, is easily possible in the case of a correspondingly straight extension of the contact conductor.

Owing to its directionally stable configuration, the contact conductor can simultaneously be aligned both with respect to the module contact and with respect to the antenna contact and can subsequently be contacted. After the contacting, the chip module can be conveyed into the cavity by pivoting the chip module around its lateral edge which is arranged adjacent to the lateral edge of the cavity. Here, the contact conductors which are contacted with the module contacts and with the antenna contacts can support the guiding of said pivoting movement as a kind of hinge ribbon.

It is particularly advantageous if, before positioning the contact conductor ends above the antenna contacts and before positioning the contact conductors above the module contacts, the chip module is positioned relative to the card body, in such a manner that the card body and the chip module are arranged in two parallel planes which are arranged offset from each other, and in such a manner that the chip module is arranged above the card body. In this manner, the contact conductors can be positioned above the respective terminal faces and the contact conductors can make contact with the terminal faces, i.e. with the antenna contacts and with the module contacts, in a relative position of the chip module and of the card body, which facilitates the subsequent insertion of the chip module into the cavity of the card body.

It is particularly advantageous if, for positioning the contact conductor ends above the antenna contacts and the contact conductor above the module contacts, the contact conductors are fed thereto along a feed axis in each case, wherein the feed axis is respectively defined by the connecting line between the respective antenna contact and the respective module contact which are to be connected to each other by means of the contact conductor. Hereby, it is possible to select a relative arrangement of the chip module and the card body which enables a continuous feeding of the contact conductors. This in particular results in the possibility of producing the chip card in a clocked process, in which the components which are positioned in a suited relative position with respect to one another, i.e. the card body and the chip module, are respectively positioned in front of a contact conductor feeding station for producing the electrically conductive connection between the card body and the chip module, and the contact conductors make contact with the antenna contacts or with the module contacts after a feed motion of the contact conductors from the contact conductor feeding station.

If, before the contact conductors are positioned relative to the module contacts and to the antenna contacts, the contact conductors are equipped with at least one predetermined kink in a contact conductor section serving for forming the wire connection between the card body and the chip module, a defined arrangement of the wire connection in the cavity after inserting the chip module into the cavity can be supported in this way.

Alternatively, it is also possible, after contacting the contact conductors with the module contacts and with the antenna contacts and after forming the wire connections by separating the contact conductor ends, to carry out forming a kink by bending the wire connections when the superposed pivoting/translational movement is carried out.

In particular in the case where, for producing the wire connection between the card body and the chip module, contact conductors are used which do not possess any connecting material coating, in particular no solder material coating, it is advantageous if, before positioning the contact conductors relative to the module contacts and to the antenna contacts, solder deposits formed in the shape of a leaf are applied onto the module contacts and onto the antenna contacts.

In particular for fixing the solder deposits for the subsequent soldering process, it is advantageous if, before applying the solder deposits onto the module contacts and onto the antenna contacts, flux deposits are applied onto the module contacts and onto the antenna contacts.

In the following, a preferred variant of the method in accordance with the invention as well as preferred embodiments of the chip card in accordance with the invention are illustrated in more detail on the basis of the drawing. In the figures:

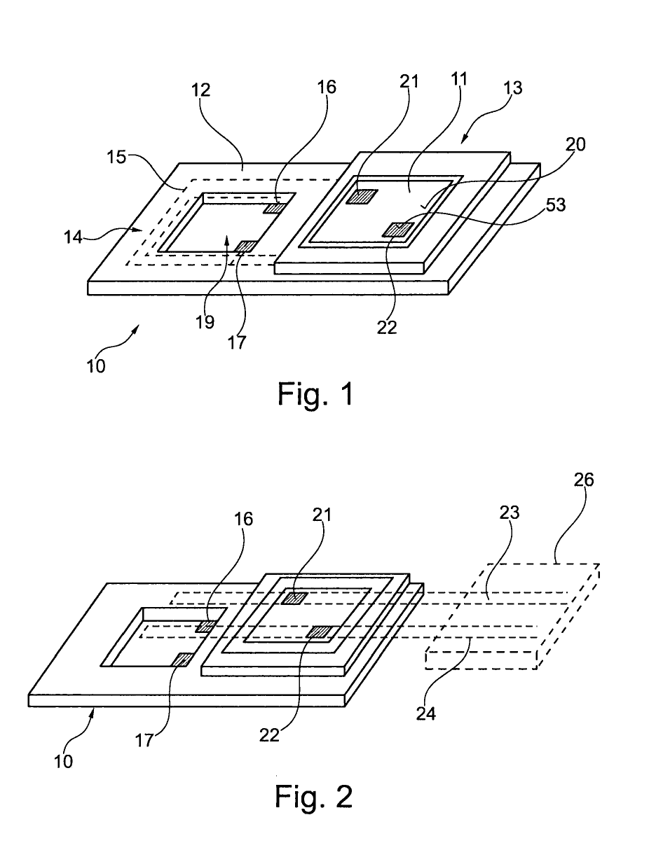

FIG. 1: shows a positioning phase during the production of a first embodiment of a chip card with a relative positioning of the chip module with respect to the card body;

FIG. 2: shows a contact conductor feeding of the contact conductors;

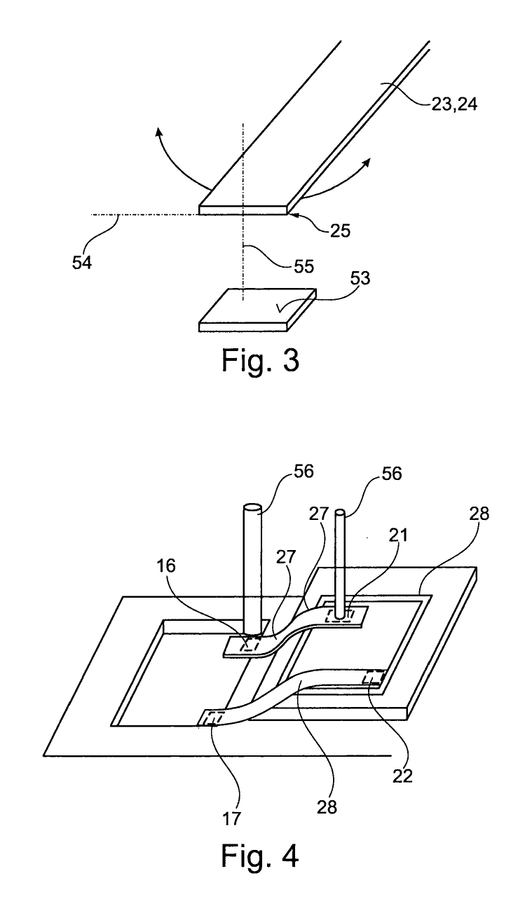

FIG. 3: shows a detailed illustration of the positioning of a contact conductor above an antenna contact of the card body or above a module contact of the chip module;

FIG. 4: shows a contacting phase with a contacting of the contact conductors for forming wire connections between an antenna of the card body and the chip module;

FIG. 5: shows an inserting phase with a pivoting of the chip module into the cavity of the card body;

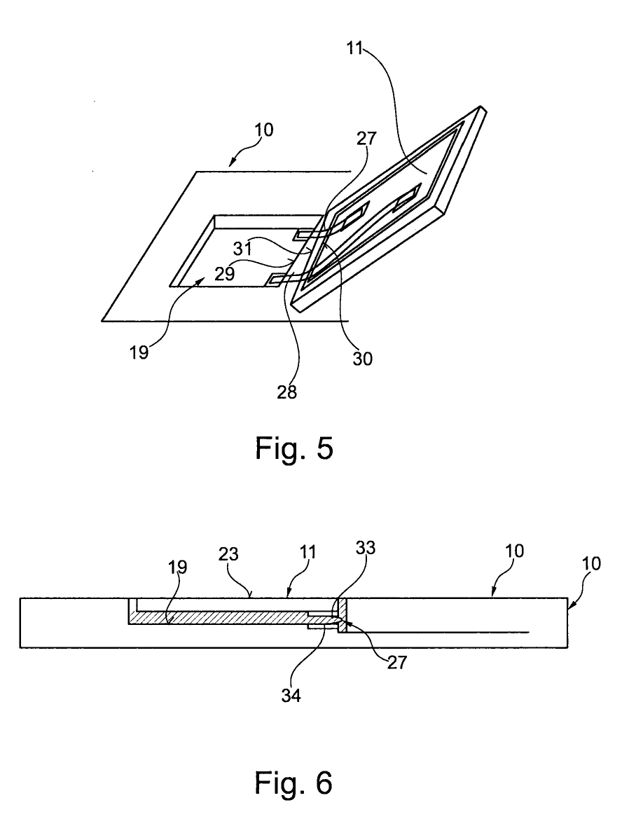

FIG. 6: shows a sectional illustration of the chip card having a chip module which is inserted into the cavity of the card body;

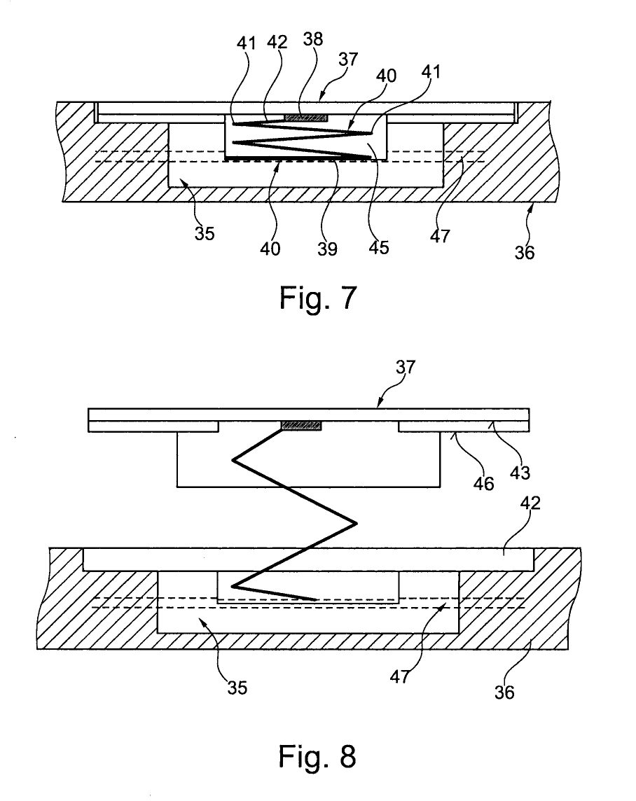

FIG. 7: shows a sectional illustration of an alternatively embodied chip card having a chip module which is inserted into the cavity of the card body;

FIG. 8: shows the chip module which is inserted into the cavity in accordance with the illustration in FIG. 7 during an inserting process;

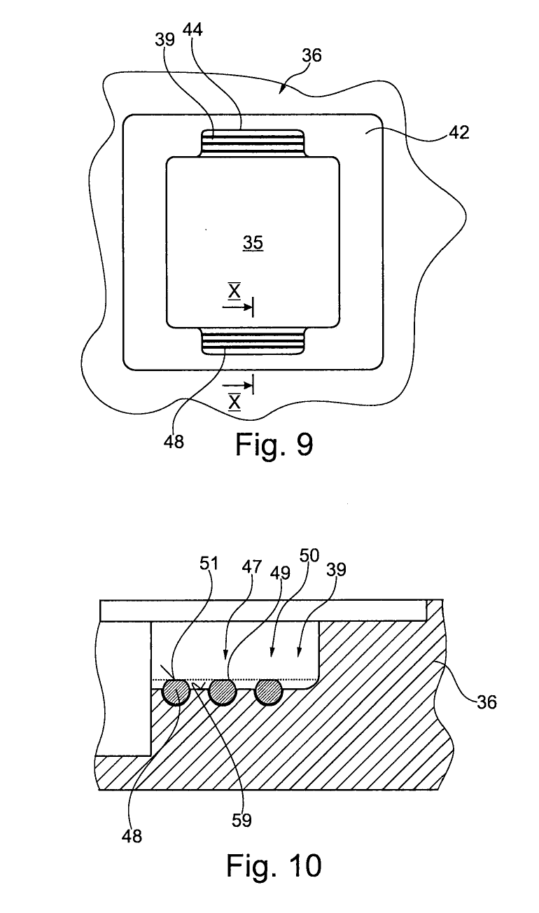

FIG. 9: shows a top view of a cavity formed in a card body;

FIG. 10: shows a partial sectional illustration of the cavity illustrated in FIG. 9;

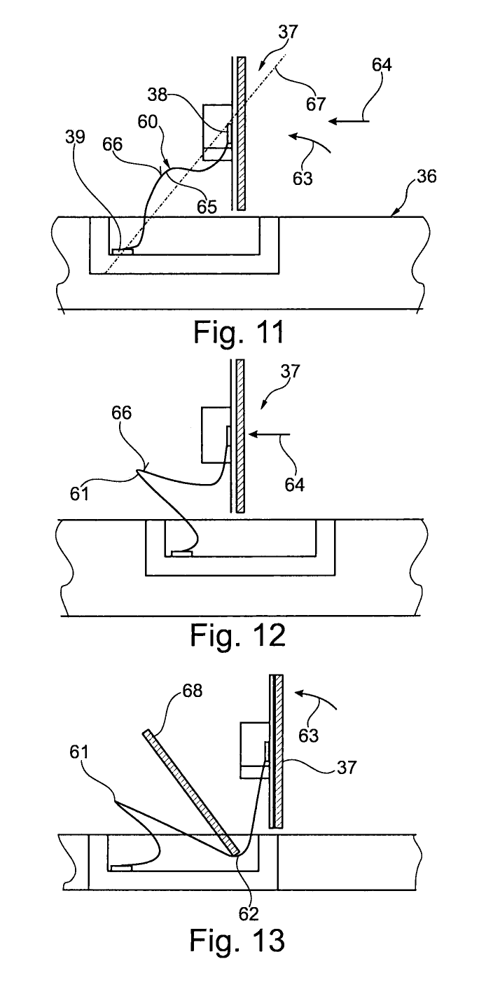

FIG. 11: shows a chip module in a first phase of a superposed pivoting/translational movement;

FIG. 12: shows the chip module in a second phase of a superposed pivoting/translational movement;

FIG. 13: shows the chip module in a third phase of a superposed pivoting/translational movement.

FIG. 1 shows a card body 10 and a chip module 11 which are arranged in two planes that are aligned parallel to each other, wherein the chip module 11 is situated in a chip module accommodation 13 which is arranged above a top side 12 of the card body 10.

The card body 10 has an antenna 14 which is arranged in the card body 10 and has an antenna conductor 15 that serves for forming antenna windings and, for a contacting with the chip module 11, has antenna contacts 16, 17 that are arranged in a bottom of a cavity 19 formed in the card body 10.

On its bottom side 20, which is aligned upwardly in FIG. 1, the chip module 11 arranged in the chip module accommodation 13 is equipped with module contacts 21, 22, which serve for a contacting with the antenna contacts 16, 17 and are arranged so as to point upwards with their contact surface 53, just like the antenna contacts 16, 17.

On its top side 23 which is opposite from the bottom side 20 (FIG. 6), the chip module 11 illustrated in FIG. 1 has a contact arrangement, which is not illustrated in detail here, and which enables a direct data access to data stored on a chip of the chip module 11, which is not illustrated in detail here. By means of the contacting with the antenna contacts 16, 17 of the antenna, the module contacts 21, 22 arranged on the bottom side 20 of the chip module 11 enable the forming of a transponder and thus, alternatively or parallel to the outer contact arrangement of the chip module 11, enable a contactless access to the data that are stored in the chip, via a suitable reading device which is not illustrated in detail here. Such chip cards, which enable both a contactless data access and a contact data access, are also referred to as Dual Interface cards (DIF).

As FIG. 2 shows, contact conductors 23, 24 are fed to the component arrangement that is composed of the card body 10 and of the chip module 11, said contact conductors having a flat ribbon cross-section 25, which, as illustrated in FIG. 3, along a transverse axis 54 running substantially parallel to the contact surface 53 of the antenna contact 16, 17 or of the module contact 21, 22 has a width which is larger than a height of the flat ribbon cross-section 25 along a vertical axis 55.

Owing to the design of the above-described cross-section, the contact conductors 23, 24, which are formed more or less like a flat ribbon, have an enlarged rigidity or a relatively large modulus of bending resistance perpendicular to the contact surface 53 of the antenna contacts 16, 17 or of the module contacts 21, 22, in such a way that the contact conductors 23, 24 or free contact conductor ends can be fed in a substantially straight line in a feed direction 26 indicated in FIG. 2, without there being an increased risk of the contact conductors 23, 24 swerving laterally. Hereby, it is possible to accurately feed the contact conductors 23, 24 for achieving an overlapping arrangement with the antenna contacts 16, 17 or the module contacts 21, 22.

Any deformation of the contact conductors 23, 24 which may arise around the transverse axis 54 or around an axis which is aligned parallel to the contact surface 53 of the antenna contacts 16, 17 or of the module contacts 21, 22 proves to be irrelevant for a following contacting process since the contacting, as illustrated in FIG. 4, is effected by means of a contacting tool 56 which, for applying the contact pressure required during the contacting, presses the contact conductors 23, 24 against the contact surface 53 of the antenna contacts 16, 17 or of the module contacts 21, 22 anyway. After completing the contacting or after contacting the contact conductors 23, 24 with the module contacts 21, 22 using the contacting tool 56 or —depending on the design of the contacting tool 26—during the contacting, contact conductor end pieces can be separated for forming a wire connection 27, 28 between one antenna contact 16 or 17 and one module contact 21 or 22 in each case.

FIG. 5 shows how the chip module 11 is conveyed or inserted into the cavity 19 by being pivoted around a lateral edge 30 of the chip module 11 which is adjacent to an opening edge 29 of the cavity 19 after producing the wire connections 27, 28 between the antenna contacts 16, 17 and the module contacts 21, 22.

With the variant of the production method illustrated in FIG. 5, in which the chip module 11 is positioned in the chip module accommodation 13, a pivoting edge 31 of the chip module accommodation 13 which is parallel to the lateral edge 30 rests on the top side 12 of the card body 10 or on a pivoting support which is not illustrated in detail here and which is arranged so as to be parallel to the top side of the card body 10, in such a way that the pivoting can be effected as a defined movement.

As a consequence of pivoting the chip module 11 or of inserting the chip module 11 into the cavity 19, a bending or a folding of the wire connections 27, 28 formed by the contact conductor pieces results, in such a manner that, as illustrated for instance in FIG. 6, wire connection sections 33, 34 formed by a kink 32 extend so as to be adjacent to one another or rest on top of one another after the chip module 11 has been inserted into the cavity 19 for forming a chip card 57.

As becomes clear from the illustrations in FIGS. 7 and 8, which show a chip module 37 of a chip card 58 accommodated in a cavity 35 of a card body 36, in this embodiment of a chip card, a wire connection 40 formed by a contact conductor end piece between a module contact 38 and an antenna contact 38 has multiple kinks 41, in such a way that the wire connection 40 is subdivided into four wire connection sections 42 in the present case. The contact conductor 23, 24 which is used for producing the wire connection 40 is equipped with predetermined kinks, which are not illustrated in detail here, and which can be formed by means of cross-section reductions of the wire cross-section of the contact conductors 23, 24, for instance by introducing linear imprints running transversely to the longitudinal extension of the contact conductors 23, 24, such that the kinks 41 are formed at defined locations when inserting the chip module 37 into the cavity 35, as illustrated schematically in FIG. 8.

As a combined view of FIGS. 8 and 9 makes clear, the cavity 35 of the card body 36 is formed in a stepped manner, having a circumferential bearing frame 42 which serves for supporting a bearing edge 43 of the chip module 37. In the area of the antenna contacts 39, the bearing frame 42 is equipped with recesses 44 which serve for uncovering the antenna contacts 39 and which simultaneously form an accommodation space or stowage space 45 for lodging the wire connection 40, as can be seen from a combined view of FIGS. 7 and 8.

For fixing the chip module 37 in the card body 36, the bearing edge 43 of the chip module 37, in the illustrated exemplary embodiment, has an adhesive coating 46 which, simultaneously with inserting the chip module 37 into the cavity 35, enables a fixing of the chip module 37 in the card body 36.

As FIGS. 9 and 10 show, the antenna contacts 39 of an antenna 47 arranged in the card body 36 are formed by an arrangement of an antenna conductor 48 in the shape of a meander, wherein the antenna conductor 48 is equipped with flat portions 51 for forming a contact surface 50 which is composed of individual contact sub-surfaces 49. For implementing an exposed arrangement of the contact surface 50 protruding from a bottom 52 of the cavity 35, the plastic material of the card body 36 in antenna conductor clearances 53 or adjacent to the antenna conductor 48 is removed by means of an ablation which is, for instance, carried out by means of laser application.

Where required, it is also possible to remove insulating lacquer layers which are situated on the antenna contacts by means of the laser application.

In FIGS. 11, 12 and 13, using the example of the chip module 37 already illustrated in FIGS. 7 and 8, an alternative configuration of a wire connection 60 is illustrated, which respectively extends between the antenna contacts 39 and module contacts 38 assigned to one another. In contrast to the wire connection 40, which is illustrated in FIGS. 7 and 8 and whose kinks 41 are formed at predetermined kink locations, which are, for instance, defined by cross-section reductions already present in the contact conductors for forming the wire connection, kinks 61 and 62 are formed at the wire connection 60 in the manner which is explained in the following referring to FIGS. 11-13.

As FIG. 11 shows, following the production of the wire connection 60 between the module contacts 38 and the antenna contacts 39, a pivoting movement 63 of the chip module 37 in the direction indicated in FIG. 11 is effected, wherein the pivoting movement is superposed by a translational movement 64 or the pivoting movement is combined with a translational movement which is effected more or less parallel to the surface of the card body 36. Owing to this feed movement of the chip module 37, which is referred to as pivoting/translational movement in the following, in the wire connection 60 a wire loop 65 is formed having a loop arch 66 which becomes narrower in the course of the pivoting/translational movement.

Along a force axis 67 connecting the module contacts 38 to the antenna contacts 39, a bending load acts upon the wire connection 60, said bending load increasing in the course of the pivoting/translational movement and leading to the wire connection 60 being bent (FIG. 12) at a predefined kink 61, as a function of the wire cross-section of the wire connection 60 and of the flexural rigidity thereof.

As FIG. 13 shows, the further kink 62 can now be formed, using a hold-down device 68 which defines a deflection location of the wire connection 60 at which the second kink 62 is formed, again upon exceeding a bending tension in the wire connection 60.

After the second kink 62 has been formed, the further pivoting/translational movement is then carried out in such a manner that the chip module 37 is inserted into the cavity 35 at the end of the movement.

1. A chip card comprising:
a card body having a top side and a cavity formed in the top side;
a chip module inserted into the cavity, said chip module having module contacts;
antenna contacts of an antenna arranged in the card body, said antenna contacts being arranged in a bottom of the cavity; and
wire connections formed by contact conductors arranged in the cavity electrically contacting the module contacts, the wire connections having a contact conductor cross-section whose width along a transverse axis arranged parallel to a contact surface of one of the antenna contacts and the module contacts is larger than a height of said cross-section along a vertical axis arranged perpendicular to the contact surface of the one of the antenna contacts and the module contacts.

2. The chip card according to claim 1, in which the contact conductor cross-section is a flat ribbon cross-section having a bottom edge and a top edge which are formed so as to be substantially parallel to the transverse axis.

3. The chip card according to claim 1, in which the contact conductor cross-section has a width at least ten times a height of the contact conductor cross-section.

4. The chip card according to claim 1, in which the contact conductors are foil strips.

5. The chip card according to claim 1, in which the contact conductors have at least one kink.

6. The chip card according to claim 5, in which for forming the at least one kink, the contact conductors have a kink cross-section having a reduced cross-sectional area.

7. The chip card according to claim 6, in which the kink cross-section has a reduced cross-sectional height.

8. A chip card having an antenna according to claim 1, in which the antenna contacts have a contact surface formed by an antenna conductor end arranged in the shape of a meander and which pertains to an antenna conductor forming the antenna.

9. The chip card according to claim 8, in which surface areas of the antenna conductor form the contact surface have a flat portion.

10. The chip card according to claim 7, in which the antenna conductor forming the antenna contacts has antenna conductor sections which are spaced apart from one another by antenna conductor clearances, said antenna conductor sections protruding from the bottom of the cavity.

11. A method for producing a chip card including a card body having a top side equipped with a cavity, an antenna arranged in the card body, and a chip module arranged in the cavity, the method comprising:
positioning the chip module with module contacts extending upwardly;
positioning the card body with antenna contacts extending upwardly;
positioning contact conductors with a flat ribbon cross-section relative to the module contacts, in such a manner that the contact conductors are aligned parallel to one another at the distance of the module contacts, extend in an overlapping position with the module contacts and extend beyond a lateral edge of the chip module together with contact conductor ends;
positioning the contact conductor ends so as to overlap the antenna contacts of the card body, wherein the chip module is arranged parallel to the top side of the card body, with the lateral edge of the chip module being arranged parallel and adjacent to an opening edge of the cavity;
contacting the contact conductors with the module contacts;
contacting the contact conductors with the antenna contacts;
separating the contact conductor ends for forming wire connections between the module contacts and the antenna contacts; and
pivoting the chip module around a lateral edge of the chip module and inserting the chip module into the cavity of the card body, in such a manner that the module contacts face the antenna contacts.

12. The method according to claim 11, in which a translational movement of the chip module superposes the pivoting of the chip module.

13. The method according to claim 12, in which before positioning the contact conductors above the antenna contacts and above the module contacts, the chip module is positioned relative to the card body, in such a manner that the card body and the chip module are arranged in two parallel planes arranged to be offset from each other, and in such a manner that the chip module is arranged above the card body.

14. The method according to claim 13, in which the chip module is arranged in a chip module accommodation which is arranged above the card body.

15. The method according to claim 13, in which for positioning the contact conductors above the antenna contacts and for positioning the contact conductors above the module contacts, the contact conductors are fed thereto along a feed axis in each case, which is in each case defined by the respective antenna contact and the respective module contact which are connected to each other by means of the contact conductor.

16. The method according to claim 11, in which before positioning the contact conductors relative to the module contacts and before positioning the contact conductors relative to the antenna contacts, the contact conductors are equipped with at least one predetermined kink, at least in the area of a contact conductor end which serves for forming the wire connection.

17. The method according to claim 12, in which after contacting the contact conductors with the module contacts and with the antenna contacts and after forming the wire connections by separating the contact conductor ends, a kink is formed by bending the wire connections when the translational movement is carried out.

18. The method according to claim 11, in which before positioning the contact conductors relative to the module contacts and before positioning the contact conductors relative to the antenna contacts, solder deposits formed in the shape of a leaf are applied onto at least one of the module contacts and the antenna contacts.

19. The method according to claim 18, in which before applying the solder deposits onto the at least one of the module contacts and the antenna contacts, flux deposits are applied onto the at least one of the module contacts and antenna contacts.
